(19) United States
(12) Patent Application Publication
(10) Pub. No.: US 2025/0347328 A1
(43) Pub. Date: Nov. 13, 2025

(54) TORQUE TUBE CENTRIFUGAL LOCKING

(71) Applicant: Nextracker LLC, Fremont, CA (US)

(72) Inventors: Abhimanyu Anil Sable, Hyderabad (IN); Ashwajit Wahane, Kalyan (IN); David E. Kresse, Walnut Creek, CA (US); Raghavendra Praveen Maddulapalli, Vijayawada (IN)

(21) Appl. No.: 19/199,697

(22) Filed: May 6, 2025

Related U.S. Application Data
(60) Provisional application No. 63/643,959, filed on May 8, 2024.

(51) Int. Cl. F16D 59/00; F16D 127/00; H02S 20/32

(52) U.S. Cl. CPC F16D 59/00; H02S 20/32; F16D 2127/002

(57) ABSTRACT

A solar tracker centrifugal locking apparatus includes a centrifugal locking device and first and second cable members. Each of the first and second cable members is connected to the centrifugal locking device and configured to connect to a torque tube. The centrifugal locking device is configured such that when the torque tube rotates in a first rotational direction at a rotational velocity below a first direction torque tube rotational velocity threshold, the centrifugal locking device is in an unlocked state to release the first cable member and receive the second cable member. And the centrifugal locking device is configured such that when the torque tube rotates in the first rotational direction at a rotational velocity at or above the first direction torque tube rotational velocity threshold, the centrifugal locking device is in a locked state to prevent further release of the first cable member.

### RELATED APPLICATIONS

This application claims the benefit of U.S. Provisional Patent Application No. 63/643,959, filed May 8, 2024, the entire contents of which are incorporated herein by reference.

### TECHNICAL FIELD

This disclosure is generally directed to device, system, and method embodiments relating to centrifugal locking mechanisms for solar trackers. Centrifugal locking mechanism embodiments disclosed herein can be used, for instance, to help control (e.g., limit) rotation of a torque tube of a solar tracker, for instance, upon occurrence of dynamic loading (e.g., wind loads) at the solar tracker.

### BACKGROUND

Solar modules can convert sunlight into energy using photovoltaic cells. Solar tracking systems can support a plurality of solar modules and function to rotate these solar modules amongst a variety of different angular orientations throughout a given day to optimize a solar irradiance angle and, thereby, optimize energy generation at the solar modules.

Solar trackers can be installed at a variety of field locations. The installed solar tracker will typically experience dynamic loads throughout its operational life, including dynamic loads, such as wind loads, resulting from environmental conditions at the solar tracker site. Wind loading, for instance from the east or west, can cause the solar tracker (e.g., torque tube) to oscillate or twist back and forth. This wind loading and resulting solar tracker oscillation can be particularly acute when the solar tracker is at certain rotational positions, such as within roughly twenty degrees of horizontal. In cases of high winds, the range of oscillation may increase to a level resulting in permanent damage to the solar tracker and accompanying solar modules.

### SUMMARY

This disclosure is generally directed to device, system, and method embodiments relating to centrifugal locking mechanisms for solar trackers. One exemplary application of centrifugal locking mechanisms embodiments disclosed herein can include rotational control of a torque tube component of a solar tracker. As one such specific example, centrifugal locking mechanisms embodiments disclosed herein can be configured to stop or limit rotation of a torque tube upon the occurrence of a dynamic load, such as upon the occurrence of wind loading experienced at the solar tracker site.

For example, centrifugal locking mechanisms embodiments disclosed herein can be configured to help control rotation of the torque tube and help to absorb energy imparted at the solar tracker (e.g., by dynamic loads). Such centrifugal locking mechanisms embodiments disclosed herein can help to reduce or prevent potentially damaging oscillation of the solar tracker (e.g., oscillation of the torque tube) due to wind, or other environmental, loads and thereby help to increase the long-term useful life of the solar tracker. For instance, a solar tracker centrifugal locking device disclosed herein can be configured to transition from an unlocked state, which can allow for substantially free rotation of the torque tube in a first and/or second rotational direction, to a locked state, which can prevent further rotation of the torque tube in that rotational direction, upon rotation and/or acceleration of the torque tube at or above a rotational velocity and/or acceleration threshold for the torque tube. Thus, for example, when the solar tracker is subjected to high dynamic loading in the field (e.g., a strong wind gust) and this high dynamic loading causes the torque tube to rotate at or beyond a threshold rotational velocity and/or acceleration, the centrifugal locking device of the solar tracker centrifugal locking apparatus can transition from an unlocked state, which permits this torque tube rotation, to a locked state, which impedes or prevents further torque tube rotation in this rotational direction.

Thus, such centrifugal locking mechanisms embodiments disclosed herein can help to absorb and dampen dynamic loads applied at the solar tracker and help to prevent or reduce damage to the solar tracker when the solar tracker is subjected to dynamic loading in the field. Moreover, the centrifugal locking mechanisms embodiments disclosed herein can help to provide a more precise degree of control over torque tube rotation (e.g., over unintended torque tube rotation) to allow for more precise tracking of the angle of the sun throughout a given day, and such centrifugal locking mechanisms embodiments disclosed herein may reduce operating costs associated with a solar tracker by replacing or augmenting traditional piston-type dampers that require routine maintenance for moving parts and oil level checks and maintenance to facilitate proper operations. Thus, the centrifugal locking mechanisms embodiments disclosed herein can both increase the precision of solar tracker control and useful tracker life while at the same time decreasing operating costs.

One solar tracker centrifugal locking apparatus embodiment includes a centrifugal locking device, a first cable member, and a second cable member. The first cable member includes a first cable member first end portion and a first cable member second end portion. The first cable member first end portion is connected to the centrifugal locking device and the first cable member second end portion is configured to connect to a torque tube of a solar tracker. The second cable member includes a second cable member first end portion and a second cable member second end portion. The second cable member first end portion is connected to centrifugal locking device, and the second cable member second end portion is configured to connect to the torque tube of the solar tracker. The centrifugal locking device is configured such that when the torque tube rotates in a first rotational direction at a rotational velocity below a first direction torque tube rotational velocity threshold, the centrifugal locking device is in an unlocked state to release a portion of the first cable member and receive a portion of the second cable member. And the centrifugal locking device is configured such that when the torque tube rotates in the first rotational direction at a rotational velocity at or above the first direction torque tube rotational velocity threshold, the centrifugal locking device is in a locked state to prevent further release of the first cable member.

In a further embodiment of this solar tracker centrifugal locking apparatus, the centrifugal locking device is configured such that when the torque tube rotates in a second rotational direction at a rotational velocity below a second direction torque tube rotational velocity threshold, the centrifugal locking device is in the unlocked state to release a portion of the second cable member and receive a portion of the first cable member, where the second rotational direction is opposite the first rotational direction. And the centrifugal locking device is configured such that when the torque tube rotates in the second rotational direction at a rotational velocity at or above the second direction torque tube rotational velocity threshold, the centrifugal locking device is in the locked state to prevent further release of the second cable member. In one such example, the centrifugal locking device can be configured to automatically transition from the unlocked state to the locked state upon torque tube rotation in the second rotational direction at a rotational velocity at or above the second direction torque tube rotational velocity threshold.

In a further embodiment of this solar tracker centrifugal locking apparatus, the centrifugal locking device is configured to mount underneath the torque tube, and the second cable member second end portion and the first cable member second end portion are configured to connect to the torque tube at opposite sides of the torque tube.

In a further embodiment of this solar tracker centrifugal locking apparatus, the first cable member second end portion is configured to connect indirectly to the torque tube via a first side of a bearing housing assembly that is directly connected to the torque tube, and the second cable member second end portion is configured to connect indirectly to the torque tube via a second, opposite side of the bearing housing assembly that is directly connected to the torque tube.

In a further embodiment of this solar tracker centrifugal locking apparatus, the centrifugal locking device includes a housing. The housing includes a first cable member receptacle extending around at least a portion of the housing and receiving the first cable member, and the housing includes a second cable member receptacle extending around at least a portion of the housing and receiving the second cable member. In one such example, the first cable member receptacle is a first groove extending around a perimeter of the housing, and the second cable member receptacle is a second groove extending around the perimeter of the housing parallel to first groove.

In a further embodiment of this solar tracker centrifugal locking apparatus, the centrifugal locking device is configured to automatically transition from the unlocked state to the locked state upon torque tube rotation in the first rotational direction at a rotational velocity at or above the first direction torque tube rotational velocity threshold. In one such example, the centrifugal locking device can include a rotational locking element, an intermediate rotational cam member, and a fixed locking interface. The rotational locking element can be configured to cause the intermediate rotational cam member to engage and disengage the fixed locking interface. For instance, the centrifugal locking device can be configured such that when the torque tube rotates in a first rotational direction at a rotational velocity below the first direction torque tube rotational velocity threshold, the intermediate rotational cam member is disengaged from the fixed locking interface to cause the centrifugal locking device to be in the unlocked state. And the centrifugal locking device can be configured such that when the torque tube rotates in the first rotational direction at a rotational velocity at or above the first direction torque tube rotational velocity threshold, the rotational locking element is caused to rotate to place the intermediate rotational cam member into engagement with the fixed locking interface to cause the centrifugal locking device to be in the locked state.

In a further embodiment of this solar tracker centrifugal locking apparatus, the apparatus further includes a mounting bracket. The mounting bracket is configured to mount the centrifugal locking device to a pier of a solar tracker below the torque tube.

Another embodiment is a method of controlling rotation of a torque tube of a solar tracker. This method embodiment includes the step of: rotating the torque tube of the solar tracker in a first rotational direction at a rotational velocity below a first direction torque tube rotational velocity threshold with a centrifugal locking device at the solar tracker in an unlocked state that allows the centrifugal locking device to release a portion of a first cable member from the centrifugal locking device and receive a portion of a second cable member at the centrifugal locking device. The first cable member connects the centrifugal locking device to a first location at the torque tube and the second cable member connects the centrifugal locking device to a second, different location at the torque tube. This method embodiment also includes the step of: upon rotating the torque tube of the solar tracker in the first rotational direction at a rotational velocity that meets or exceeds the first direction torque tube rotational velocity threshold, transitioning the centrifugal locking device at the solar tracker from the unlocked state to a locked state that prevents the centrifugal locking device from further releasing the first cable member from the centrifugal locking.

In a further embodiment of this method, the method additionally includes a step of: rotating the torque tube of the solar tracker in a second, opposite rotational direction at a rotational velocity below a second direction torque tube rotational velocity threshold with the centrifugal locking device at the solar tracker in the unlocked state that allows the centrifugal locking device to release a portion of the second cable member from the centrifugal locking device and receive a portion of the first cable member at the centrifugal locking device. In a still further embodiment of this method, the method further includes a step of: upon rotating the torque tube of the solar tracker in the second, opposite rotational direction at a rotational velocity that meets or exceeds the second direction torque tube rotational velocity threshold, transitioning the centrifugal locking device at the solar tracker from the unlocked state to the locked state that prevents the centrifugal locking device from further releasing the second cable member from the centrifugal locking device. For example, the centrifugal locking device can be configured to automatically transition from the unlocked state to the locked state upon the torque tube rotating at a rotational velocity that meets or exceeds either of the first direction torque tube rotational velocity threshold and the second direction torque tube rotational velocity threshold. For instance, in some applications, this can include the centrifugal locking device being configured to transition from unlocked state to the locked state upon an applied wind load at the solar tracker causing the torque tube to rotate in the first rotational direction at a rotational velocity that meets or exceeds the first direction torque tube rotational velocity threshold.

In a further embodiment of this method, the centrifugal locking device includes a housing. The housing includes a first cable member receptacle groove extending around a perimeter of the housing and receiving the first cable member, and the housing includes a second cable member receptacle groove extending around the perimeter of the housing parallel to the first cable member receptacle groove and receiving the second cable member.

In a further embodiment of this method, the method additionally includes a step of: transitioning the centrifugal locking device from the locked state to the unlocked state upon termination of rotation of the torque tube in the first rotational direction at the rotational velocity that meets or exceeds the first direction torque tube rotational velocity threshold for a predetermined period of time.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is an elevational view of an embodiment of a solar tracker.

FIG. 2 is an elevational view of an embodiment of a solar tracker centrifugal locking apparatus installed at a solar tracker.

FIG. 3 is a plan view of exemplary interior components of an embodiment of a centrifugal locking device of the solar tracker centrifugal locking apparatus of FIG. 2.

FIG. 4 is a perspective view of the solar tracker centrifugal locking apparatus of FIG. 2 with the torque tube rotated in a first rotational direction to cause the centrifugal locking device to transition from an unlocked to a locked state.

FIG. 5 is a perspective view of the solar tracker centrifugal locking apparatus of FIG. 2 with the torque tube rotated in a second, opposite rotational direction to cause the centrifugal locking device to transition from an unlocked to a locked state.

FIG. 6 is a flow diagram of an embodiment of a method of controlling rotation of a torque tube of a solar tracker.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

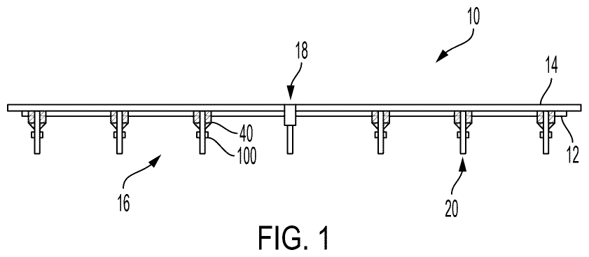

FIG. 1 illustrates an elevational view of a solar tracker 10. The solar tracker 10 can include a plurality of piers 20 disposed in spaced relation to one another and embedded in the earth. A torque tube 12 can extend between adjacent piers 20, and the torque tube 12 can be rotatably supported on each pier 20 such that the torque tube 12 can rotate relative to the piers 20, for instance, in each of a first rotational direction and a second, opposite rotational direction. The solar tracker 10 can also include a plurality of solar panels 14 supported on the torque tube 12, and the solar panels 14 can include photovoltaic cells that are configured to convert sunlight into electrical energy. The span between two adjacent piers 20 can be referred to as a bay 16 (e.g., which can in the range of about 8 meters in length). The illustrated embodiment shows a row formed by the solar tracker 10, and the row can be arranged in a north-south longitudinal orientation. In many applications, a plurality of rows can be included, spaced apart from one another, and each arranged in a north-south longitudinal orientation to collectively form a solar array at the solar tracker.

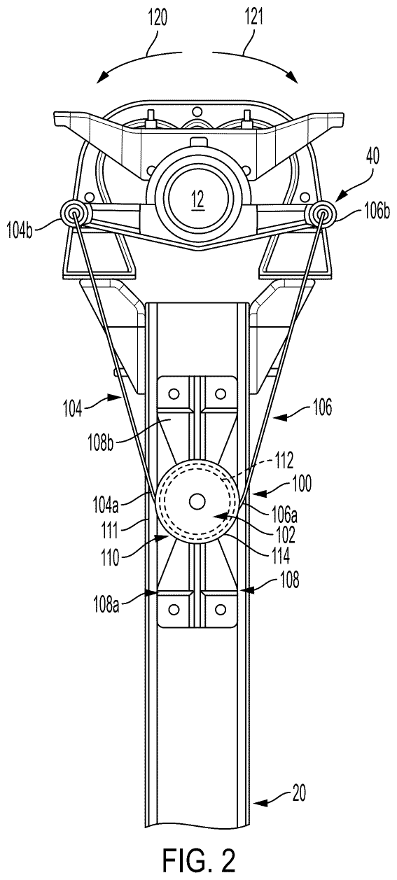

As noted, the torque tube 12 can rotate, which thereby rotates the solar panels 14. In particular, the torque tube 12 can be rotated throughout a given day to track the position of the sun and thereby better optimize the angle between the sun and the solar panels 14 throughout the day. To facilitate rotation of the torque tube 12 between a variety of rotational positions, the solar tracker 10 can additionally include a motive source that is configured to impart rotational force on the torque tube. The illustrated embodiment shows the solar tracker 10 as including a drive mechanism (e.g., motor, slew drive, etc.) 18 operably coupled to the torque tube 12 and supported on a respective pier of the plurality of piers 20. The drive mechanism 18 can effectuate rotation of the torque tube 12, which in turn can effectuate a corresponding rotation of the solar panels 14 to track the location of the sun. To support and help accommodate rotation of the torque tube 12, the solar tracker 10 can include a plurality of bearing housing assemblies (BHA) 40 disposed on respective piers 20 of the plurality of piers 20. Each of the plurality of bearing housing assemblies 40 is operably coupled to the torque tube 12 to rotatably support the torque tube 12 therein (e.g., as shown at FIGS. 2, 4, and 5) as the torque tube 12 is caused to be rotated by the drive mechanism 18.

When installed in the field, the solar tracker 10 can be subjected to dynamic load, such as wind loads, resulting from environmental conditions at the solar tracker site. Wind loading, for instance from the east or west, can cause the solar tracker 10 (e.g., torque tube 12) to oscillate or twist back and forth. Depending on the magnitude of the dynamic load, the range of oscillation may increase to a level resulting in permanent damage to the solar tracker 10 and accompanying solar modules. To help absorb energy imparted at the solar tracker 10 by such dynamic loads, the solar tracker 10 can include one or more solar tracker centrifugal locking apparatuses 100 which can help to reduce or prevent oscillation of the solar tracker 10 (e.g., oscillation of the torque tube 12) due to wind, or other environmental, loads and thereby help to increase the long-term useful life of the solar tracker 10. Exemplary details of the solar tracker centrifugal locking apparatus 100 will be described as follows.

The solar tracker centrifugal locking apparatus 100 can be configured to transition from an unlocked state, which can allow for substantially free rotation of the torque tube 12 in a first and/or second rotational direction, to a locked state, which can prevent further rotation of the torque tube in that rotational direction, upon rotation of the torque tube 12 at or above a rotational velocity threshold for the torque tube 12. Thus, for example, when the solar tracker 10 is subjected to high dynamic loading in the field (e.g., a strong wind gust) and this high dynamic loading causes the torque tube to rotate at or beyond a threshold rotational velocity, a centrifugal locking device of the solar tracker centrifugal locking apparatus 100 can transition from an unlocked state, which permits this torque tube rotation, to a locked state, which impedes or prevents further torque tube rotation in this rotational direction.

As such, the solar tracker centrifugal locking apparatus 100 can help to absorb and dampen dynamic loads applied at the solar tracker 10 and help to prevent or reduce damage to the solar tracker 10 when the solar tracker 10 is subjected to dynamic loading in the field. In some examples, the solar tracker centrifugal locking apparatus 100 can augment or replace traditional dampers used at a solar tracker. Notably, the solar tracker centrifugal locking apparatus 100 can provide advantages over traditional dampers in that the solar tracker centrifugal locking apparatus 100 may have less moving parts and require less maintenance in the field. As one such example, a damper may need to have its oil level routinely checked and re-filled to operate as intended, whereas the solar tracker centrifugal locking apparatus 100 may not necessitate as frequent maintenance and thereby help to reduce operating costs associated with a solar tracker.

FIG. 2 illustrates an elevational view of an embodiment of solar tracker centrifugal locking apparatus 100 installed at a pier 20 of a solar tracker (e.g., the solar tracker 10 of FIG. 1). A solar tracker row can include one or more solar tracker centrifugal locking apparatuses 100, for instance, to help dampen dynamic loading (e.g., wind loading) and prevent over-rotation of the torque tube and, thereby, help to increase the useful life of the solar tracker in a cost effective manner.

The solar tracker centrifugal locking apparatus 100 can include a centrifugal locking device 102, a first cable member 104, and a second cable member 106. The first cable member 104 can include a first cable member first end portion 104a and a first cable member second end portion 104b. The first cable member first end portion 104a can be connected to the centrifugal locking device 102, and the first cable member second end portion 104b can be configured to connect to torque tube 12 of a solar tracker. Likewise, the second cable member 106 can include a second cable member first end portion 106a and a second cable member second end portion 106b. The second cable member first end portion 106a can be connected to the centrifugal locking device 102, and the second cable member second end portion 106b can be configured to connect to the torque tube 12 of the solar tracker.

In addition to the centrifugal locking device 102, the first cable member 104, and the second cable member 106, the solar tracker centrifugal locking apparatus 100 can also include a mounting bracket 108. The mounting bracket 108 can be configured to mount the centrifugal locking device 102 to a pier 20 of a solar tracker. For example, as shown for the embodiment here, the mounting bracket 108 can be configured to mount the centrifugal locking device 102 to pier 20 of a solar tracker below the torque tube 12 of the solar tracker. The mounting bracket 108 can include a first mounting bracket portion 108a that is configured to mount to an upper portion of the centrifugal locking device 102 and a second mounting bracket portion 108b that is configured to mount to a lower portion of the centrifugal locking device 102. The mounting bracket can be configured to mount to the centrifugal locking device 102 at a location on the centrifugal locking device 102 that is spaced apart from the location of each of the first and second cable members 104, 106 at the centrifugal locking device 102.

For example, as shown for the illustrated embodiment here, the centrifugal locking device 102 can be configured to mount underneath the torque tube 12, and the first cable member second end portion 104b and the second cable member second end portion 106b can be configured to connect to the torque tube 12 at opposite sides of the torque tube 12. The cables 104, 106 can be configured to connect to the torque tube 12 directly or indirectly. The illustrated embodiment shows that the first cable member second end portion 104b can be configured to connect indirectly to the torque tube 12 via a first side of a bearing housing assembly 40 that is directly connected to the torque tube 12, and the second cable member second end portion 106b can be configured to connect indirectly to the torque tube 12 via a second, opposite side of the bearing housing assembly 40 that is directly connected to the torque tube 12. In other embodiments the cables 104, 106 can connect directly at the torque tube 12.

The illustrated embodiment shows that the centrifugal locking device 102 can include a housing 110. The housing 110 can be configured to release and receive the first and second cable members 104, 106. For instance, the housing 110 can include a first cable member receptacle 111 extending around at least a portion of the housing 110 and receiving the first cable member 104, and the housing 110 can include a second cable member receptacle 112 extending around at least a portion of the housing 110 and receiving the second cable member 106. As one such example, the first cable member receptacle 111 can, for instance, be a first groove extending around a perimeter 114 of the housing 110, and the second cable member receptacle 112 can, for instance, be a second groove extending around the perimeter 114 of the housing 110 parallel to, and offset from, the first groove. The first cable member receptacle 111 can receive and release a portion of the first cable member 104 from the housing 110 when the centrifugal locking device 102 is in an unlocked state and the torque tube 12 is rotated in a first rotational direction 120 and/or a second, opposite rotational direction 121. Similarly, the second cable member receptacle 112 can receive and release a portion of the second cable member 106 from the housing 110 when the centrifugal locking device 102 is in an unlocked state and the torque tube 12 is rotated in a first rotational direction 120 and/or a second, opposite rotational direction 121.

The centrifugal locking device 102 can be configured to transition between unlocked and locked states to help control rotation of the torque tube 12. When the centrifugal locking device 102 is in the unlocked state, the centrifugal locking device 102 can allow for substantially free rotation of the torque tube 12 in a first and/or second rotational directions 120, 121 by being configured in the unlocked state to: (i) freely release the first cable member 104 when the torque tube 12 is rotated in the second rotational direction 121 and/or (ii) freely release the second cable member 106 when the torque tube 12 is rotated in the first rotational direction 120. When rotation of the torque tube in either rotational direction 120, 121 exceeds a torque tube rotational velocity threshold (e.g., as a result of a strong wind gust applied at the solar tracker in the field), the centrifugal locking device 102 can be configured to transition from the unlocked state to a locked state. When the centrifugal locking device 102 is in the locked state, the centrifugal locking device 102 can prevent further rotation of the torque tube in that same rotational direction by preventing further release of the first cable member 104 in the case of further torque tube rotation at or above the torque tube rotational velocity threshold in the rotational direction 121 and by preventing further release of the second cable member 106 in the case of further torque tube rotation at or above the torque tube rotational velocity threshold in the rotational direction 120.

With respect to one rotational direction 120 of the torque tube 12, the centrifugal locking device 102 can be configured such that when the torque tube 12 rotates in the rotational direction 120 at a rotational velocity below a first direction torque tube rotational velocity threshold, the centrifugal locking device 102 is in an unlocked state to release a portion of the second cable member 106 and receive a portion of the first cable member 104. Also, the centrifugal locking device 102 can be configured such that when the torque tube 12 rotates in that same rotational direction 120 at a rotational velocity at or above the first direction torque tube rotational velocity threshold, the centrifugal locking device 102 is in a locked state to prevent further release of the second cable member 106. In this way, with respect to the rotational direction 120 of the torque tube 12, the centrifugal locking device 102 can be configured to allow for free torque tube rotation in the direction 120 until the rotational velocity of the torque tube in the direction 120 meets or exceeds the first direction torque tube rotational velocity threshold at which time the centrifugal locking device 102 is caused to transition to the locked state to thereby prevent further rotation of the torque tube 12 in the direction 120 by restraining further release of the second cable member 106. In some examples, depending on the specific configuration of the centrifugal locking device 102, the centrifugal locking device 102 can be configured to automatically transition from the unlocked state to the locked state upon torque tube rotation in the rotational direction 120 at a rotational velocity at or above the first direction torque tube rotational velocity threshold.

Similarly with respect to the other, opposite rotational direction 121 of the torque tube 12, the centrifugal locking device 102 can be configured such that when the torque tube 12 rotates in the other rotational direction 121 at a rotational velocity below a second direction torque tube rotational velocity threshold, the centrifugal locking device 102 is in an unlocked state to release a portion of the first cable member 104 and receive a portion of the second cable member 106. Also, the centrifugal locking device 102 can be configured such that when the torque tube 12 rotates in that same rotational direction 121 at a rotational velocity at or above the second direction torque tube rotational velocity threshold, the centrifugal locking device 102 is in a locked state to prevent further release of the first cable member 104. In this way, with respect to the rotational direction 121 of the torque tube 12, the centrifugal locking device 102 can be configured to allow for free torque tube rotation in the direction 121 until the rotational velocity of the torque tube in the direction 121 meets or exceeds the second direction torque tube rotational velocity threshold at which time the centrifugal locking device 102 is caused to transition to the locked state to thereby prevent further rotation of the torque tube 12 in the direction 121 by restraining further release of the first cable member 104. In some examples, depending on the specific configuration of the centrifugal locking device 102, the centrifugal locking device 102 can be configured to automatically transition from the unlocked state to the locked state upon torque tube rotation in the rotational direction 121 at a rotational velocity at or above the second direction torque tube rotational velocity threshold.

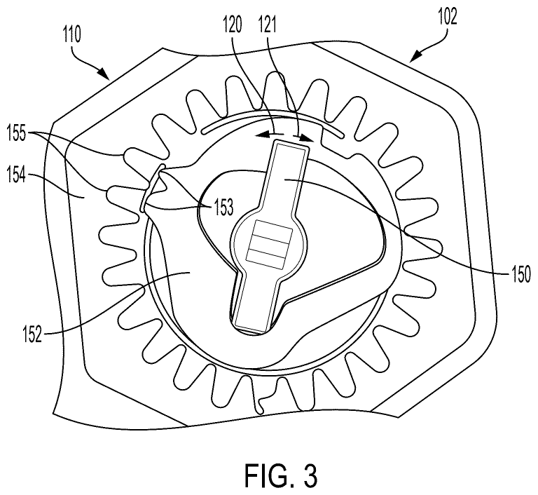

FIG. 3 illustrates a plan view of exemplary interior components of one embodiment of centrifugal locking device 102. The configuration and components of the centrifugal locking device 102 shown here at FIG. 3 are exemplary and it is to be noted that other configurations and components can be used for the centrifugal locking device 102 to execute the described function to transition between unlocked and locked states as a result of torque tube rotational velocity exceeding a preset rotational velocity threshold.

The example of FIG. 3 shows that the centrifugal locking device 102 can include components that configure the centrifugal locking device 102 to be responsive to excessive rotational velocity and/or excessive rotational acceleration of the torque tube. Namely, the centrifugal locking device 102 can include components that configure the centrifugal locking device 102 to transition from an unlocked state to a locked state, which can prevent further rotation of the centrifugal locking device 102, in response to torque tube rotational velocity and/or torque tube rotational acceleration meeting or exceeding a torque tube rotational velocity or acceleration threshold. FIG. 3 illustrates one example configuration of such components at the centrifugal locking device 102, though other embodiments within the scope of this disclosure can include alternate or additional components directed to executing the noted function of the centrifugal locking device 102.

The example here at FIG. 3 shows that the centrifugal locking device 102 can include a rotational locking element 150, an intermediate rotational cam member 152, and a fixed locking interface 154. The rotational locking element 150 can rotate within the housing 110. When the torque tube is rotated in the direction 120, this can cause the second cable member 106 to be pulled from the housing 110 of the centrifugal locking device 102 which in turn can cause the rotational locking element 150 to also rotate in the direction 120. For example, the centrifugal locking device 102 can be configured such that when the torque tube rotates in the rotational direction 120 at a rotational velocity below the first direction torque tube rotational velocity or acceleration threshold, the intermediate rotational cam member 152 is disengaged from the fixed locking interface 154 (e.g., teeth 153 of intermediate rotational cam member 152 are disengaged from complementary, meshable teeth 155 of the fixed locking interface 154) to cause the centrifugal locking device 102 to be in the unlocked state. But as the rotational locking element 150 is caused to so rotate in the direction 120 as a result of pulled release of the second cable member 106, when the torque tube rotational velocity and/or torque tube rotational acceleration in the direction 120 meets or exceeds a torque tube first direction rotational velocity or acceleration threshold, the rotational locking element 150 can be configured to cause the intermediate rotational cam member 152 to engage the fixed locking interface 154 to thereby put the centrifugal locking device 102 in the locked state.

Likewise, when the torque tube is rotated in the direction 121, this can cause the first cable member 104 to be pulled from the housing 110 of the centrifugal locking device 102 which in turn can cause the rotational locking element 150 to also rotate in the direction 121. For example, the centrifugal locking device 102 can be configured such that when the torque tube rotates in the rotational direction 121 at a rotational velocity below the second direction torque tube rotational velocity or acceleration threshold, the intermediate rotational cam member 152 is disengaged from the fixed locking interface 154 (e.g., teeth 153 of intermediate rotational cam member 152 are disengaged from complementary, meshable teeth 155 of the fixed locking interface 154) to cause the centrifugal locking device 102 to be in the unlocked state. But as the rotational locking element 150 is caused to so rotate in the direction 121 as a result of pulled release of the first cable member 104, when the torque tube rotational velocity and/or torque tube rotational acceleration in the direction 121 meets or exceeds a torque tube second direction rotational velocity or acceleration threshold, the rotational locking element 150 can be configured to cause the intermediate rotational cam member 152 to engage the fixed locking interface 154 to thereby put the centrifugal locking device 102 in the locked state.

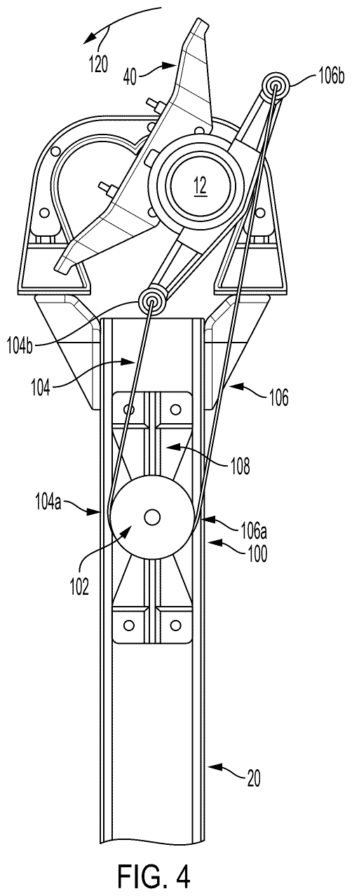

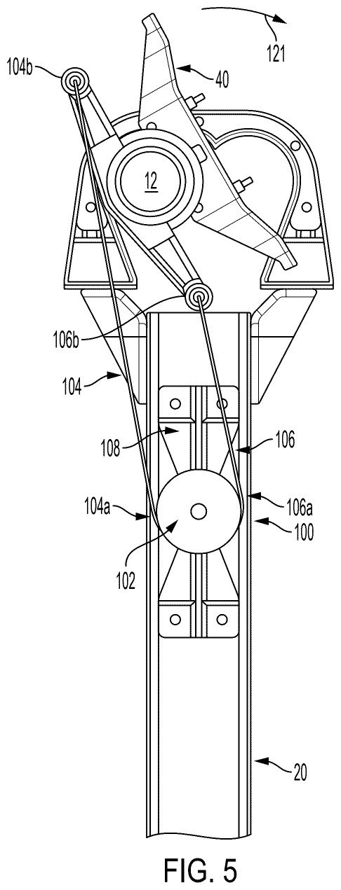

FIGS. 4 and 5 show the centrifugal locking device 102 transitioned from the unlocked state to the locked state when the torque tube 12 is rotated in different rotational directions. The examples shown at FIGS. 4 and 5 show a sixty degree tilt position (sixty degree tilt east; sixty degree tilt west) of the torque tube as being a tilt position at which the centrifugal locking device 102 transitions from the unlocked state to the locked state. Though other embodiments within the scope of this disclosure can be configured to transition the centrifugal locking device 102 from the unlocked state to the locked state at other torque tube tilt positions.

FIG. 4 illustrates a perspective view of the solar tracker centrifugal locking apparatus 100 with the torque tube 12 rotated in rotational direction 120 to cause the centrifugal locking device 102 to transition from the unlocked to the locked state. For instance, when the torque tube 12 is rotated in the direction 120 at a rotational velocity and/or rotational acceleration below a first direction torque tube rotational velocity and/or rotational acceleration threshold, the centrifugal locking device 102 can be configured to be in the unlocked state to allow for release of a portion of the second cable member 106 to thereby allow the torque tube 12 to continue to rotate in the direction 120. But when the rotational velocity and/or rotational acceleration of the torque tube 12 in the direction 120 meets or exceeds the first direction torque tube rotational velocity and/or rotational acceleration threshold, the centrifugal locking device 102 can be configured to transition from the unlocked state to the locked state so as to prevent further release of the second cable member 106 from the centrifugal locking device 102 to thereby prevent the torque tube 12 from further rotation in the direction 120 by constraining further release of the second cable member 106 from the centrifugal locking device 102. As one example, the centrifugal locking device 102 can then later be configured to transition from this locked state back to the unlocked state when rotation of the torque tube 12 in the direction 120 falls back below the first direction torque tube rotational velocity and/or rotational acceleration threshold.

FIG. 5 illustrates a perspective view of the solar tracker centrifugal locking apparatus 100 with the torque tube 12 rotated in an opposite rotational direction 121 to cause the centrifugal locking device 102 to transition from the unlocked to the locked state. For instance, when the torque tube 12 is rotated in the direction 121 at a rotational velocity and/or rotational acceleration below a second direction torque tube rotational velocity and/or rotational acceleration threshold, the centrifugal locking device 102 can be configured to be in the unlocked state to allow for release of a portion of the first cable member 104 to thereby allow the torque tube 12 to continue to rotate in the direction 121. But when the rotational velocity and/or rotational acceleration of the torque tube 12 in the direction 121 meets or exceeds the second direction torque tube rotational velocity and/or rotational acceleration threshold, the centrifugal locking device 102 can be configured to transition from the unlocked state to the locked state so as to prevent further release of the first cable member 104 from the centrifugal locking device 102 to thereby prevent the torque tube 12 from further rotation in the direction 121 by constraining further release of the first cable member 104 from the centrifugal locking device 102. As one example, the centrifugal locking device 102 can then later be configured to transition from this locked state back to the unlocked state when rotation of the torque tube 12 in the direction 121 falls back below the second direction torque tube rotational velocity and/or rotational acceleration threshold.

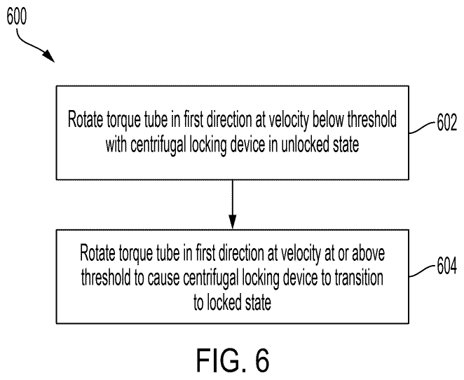

FIG. 6 illustrates a flow diagram of an embodiment of a method 600 of controlling rotation of a torque tube of a solar tracker. For instance, the method 600 can be executed using any one or more features of the exemplary embodiments disclosed elsewhere herein, for instance, using the solar tracker 10, the solar tracker centrifugal locking apparatus 100, and/or the centrifugal locking device 102.

At step 602, the method 600 includes rotating a torque tube of a solar tracker in a first rotational direction at a rotational velocity below a first direction torque tube rotational velocity threshold with a centrifugal locking device at the solar tracker in an unlocked state. The unlocked state of the centrifugal locking device allows the centrifugal locking device to release a portion of a first cable member from the centrifugal locking device and receive a portion of a second cable member at the centrifugal locking device. This first cable member can connect the centrifugal locking device to a first location at the torque tube and this second cable member can connect the centrifugal locking device to a second, different location at the torque tube.

At step 604, the method 600 includes, upon rotating the torque tube of the solar tracker in the first rotational direction at a rotational velocity that meets or exceeds the first direction torque tube rotational velocity threshold, transitioning the centrifugal locking device at the solar tracker from the unlocked state to a locked state. The locked state of the centrifugal locking device prevents the centrifugal locking device from further releasing the first cable member from the centrifugal locking, which can act to impede the torque tube from rotating further in this same rotational direction.

In a further embodiment of the method 600, one or more additional steps can be included. For example, in some applications the method 600 can include an additional step of rotating the torque tube of the solar tracker in a second, opposite rotational direction at a rotational velocity below a second direction torque tube rotational velocity threshold with the centrifugal locking device at the solar tracker in the unlocked state. This unlocked state of the centrifugal locking device can allow the centrifugal locking device to release a portion of the second cable member from the centrifugal locking device and receive a portion of the first cable member at the centrifugal locking device. As a further specific such example, the method 600 can also further include an additional step of, upon rotating the torque tube of the solar tracker in the second, opposite rotational direction at a rotational velocity that meets or exceeds the second direction torque tube rotational velocity threshold, transitioning the centrifugal locking device at the solar tracker from the unlocked state to the locked state. This locked state of the centrifugal locking device can prevent the centrifugal locking device from further releasing the second cable member from the centrifugal locking device, which can act to impede the torque tube from rotating further in this same rotational direction.

In some such applications of the method 600, the centrifugal locking device can be configured to automatically transition from the unlocked state to the locked state upon the torque tube rotating at a rotational velocity that meets or exceeds either of the first direction torque tube rotational velocity threshold and the second direction torque tube rotational velocity threshold. In some such applications of the method 600, the centrifugal locking device can be configured to transition from unlocked state to the locked state upon an applied wind load at the solar tracker causing the torque tube to rotate in the first rotational direction at a rotational velocity that meets or exceeds the first direction torque tube rotational velocity threshold or causing the torque tube to rotate in the second, opposite rotational direction at a rotational velocity that meets or exceeds the second direction torque tube rotational velocity threshold.

In one yet further embodiment of the method 600, one or more steps can be included for transitioning the centrifugal locking device from the locked state to the unlocked state. Such action can be taken manually or in an automated manner. As one example of an automated manner for transitioning the centrifugal locking device from the locked state to the unlocked state, so as to again allow the torque tube to freely rotate without significant impediment from the centrifugal locking device, the centrifugal locking device can be transitioned from the locked state to the unlocked state upon termination of rotation of the torque tube in the first rotational direction at the rotational velocity that meets or exceeds the first direction torque tube rotational velocity threshold for a predetermined period of time. For instance, when a wind load (e.g., wind gust) at the solar tracker terminates for more than the predetermined period of time, the centrifugal locking device can be caused to change from the locked state to the unlocked state to again allow for free rotation of the torque tube.

Various examples have been described. These and other examples are within the scope of the following claims.

What is claimed is:

1. A solar tracker centrifugal locking apparatus comprising:
a centrifugal locking device;
a first cable member comprising a first cable member first end portion and a first cable member second end portion, the first cable member first end portion connected to the centrifugal locking device, the first cable member second end portion configured to connect to a torque tube of a solar tracker; and
a second cable member comprising a second cable member first end portion and a second cable member second end portion, the second cable member first end portion connected to the centrifugal locking device, the second cable member second end portion configured to connect to the torque tube of the solar tracker,
wherein the centrifugal locking device is configured such that when the torque tube rotates in a first rotational direction at a rotational velocity below a first direction torque tube rotational velocity threshold, the centrifugal locking device is in an unlocked state to release a portion of the first cable member and receive a portion of the second cable member, and
wherein the centrifugal locking device is configured such that when the torque tube rotates in the first rotational direction at a rotational velocity at or above the first direction torque tube rotational velocity threshold, the centrifugal locking device is in a locked state to prevent further release of the first cable member.

2. The apparatus of claim 1, wherein the centrifugal locking device is configured such that when the torque tube rotates in a second rotational direction at a rotational velocity below a second direction torque tube rotational velocity threshold, the centrifugal locking device is in the unlocked state to release a portion of the second cable member and receive a portion of the first cable member, the second rotational direction being opposite the first rotational direction.

3. The apparatus of claim 2, wherein the centrifugal locking device is configured such that when the torque tube rotates in the second rotational direction at a rotational velocity at or above the second direction torque tube rotational velocity threshold, the centrifugal locking device is in the locked state to prevent further release of the second cable member.

4. The apparatus of claim 3, wherein the centrifugal locking device is configured to automatically transition from the unlocked state to the locked state upon torque tube rotation in the second rotational direction at a rotational velocity at or above the second direction torque tube rotational velocity threshold.

5. The apparatus of claim 1, wherein the centrifugal locking device is configured to mount underneath the torque tube, and wherein the second cable member second end portion and the first cable member second end portion are configured to connect to the torque tube at opposite sides of the torque tube.

6. The apparatus of claim 1, wherein the first cable member second end portion is configured to connect indirectly to the torque tube via a first side of a bearing housing assembly that is directly connected to the torque tube, and wherein the second cable member second end portion is configured to connect indirectly to the torque tube via a second, opposite side of the bearing housing assembly that is directly connected to the torque tube.

7. The apparatus of claim 1, wherein the centrifugal locking device comprises a housing, the housing comprising a first cable member receptacle extending around at least a portion of the housing and receiving the first cable member, the housing comprising a second cable member receptacle extending around at least a portion of the housing and receiving the second cable member.

8. The apparatus of claim 7, wherein the first cable member receptacle is a first groove extending around a perimeter of the housing, and wherein the second cable member receptacle is a second groove extending around the perimeter of the housing parallel to first groove.

9. The apparatus of claim 1, wherein the centrifugal locking device is configured to automatically transition from the unlocked state to the locked state upon torque tube rotation in the first rotational direction at a rotational velocity at or above the first direction torque tube rotational velocity threshold.

10. The apparatus of claim 9, wherein the centrifugal locking device comprises a rotational locking element, an intermediate rotational cam member, and a fixed locking interface, the rotational locking element configured to cause the intermediate rotational cam member to engage and disengage the fixed locking interface.

11. The apparatus of claim 10, wherein the centrifugal locking device is configured such that when the torque tube rotates in a first rotational direction at a rotational velocity below the first direction torque tube rotational velocity threshold, the intermediate rotational cam member is disengaged from the fixed locking interface to cause the centrifugal locking device to be in the unlocked state.

12. The apparatus of claim 11, wherein the centrifugal locking device is configured such that when the torque tube rotates in the first rotational direction at a rotational velocity at or above the first direction torque tube rotational velocity threshold, the rotational locking element is caused to rotate to place the intermediate rotational cam member into engagement with the fixed locking interface to cause the centrifugal locking device to be in the locked state.

13. The apparatus of claim 1, further comprising:
a mounting bracket configured to mount the centrifugal locking device to a pier of a solar tracker below the torque tube.

14. A method comprising the steps of:
rotating a torque tube of a solar tracker in a first rotational direction at a rotational velocity below a first direction torque tube rotational velocity threshold with a centrifugal locking device at the solar tracker in an unlocked state that allows the centrifugal locking device to release a portion of a first cable member from the centrifugal locking device and receive a portion of a second cable member at the centrifugal locking device, the first cable member connecting the centrifugal locking device to a first location at the torque tube and the second cable member connecting the centrifugal locking device to a second, different location at the torque tube, and
upon rotating the torque tube of the solar tracker in the first rotational direction at a rotational velocity that meets or exceeds the first direction torque tube rotational velocity threshold, transitioning the centrifugal locking device at the solar tracker from the unlocked state to a locked state that prevents the centrifugal locking device from further releasing the first cable member from the centrifugal locking.

15. The method of claim 14, further comprising the step of:
rotating the torque tube of the solar tracker in a second, opposite rotational direction at a rotational velocity below a second direction torque tube rotational velocity threshold with the centrifugal locking device at the solar tracker in the unlocked state that allows the centrifugal locking device to release a portion of the second cable member from the centrifugal locking device and receive a portion of the first cable member at the centrifugal locking device.

16. The method of claim 15, further comprising:
upon rotating the torque tube of the solar tracker in the second, opposite rotational direction at a rotational velocity that meets or exceeds the second direction torque tube rotational velocity threshold, transitioning the centrifugal locking device at the solar tracker from the unlocked state to the locked state that prevents the centrifugal locking device from further releasing the second cable member from the centrifugal locking device.

17. The method of claim 16, wherein the centrifugal locking device is configured to automatically transition from the unlocked state to the locked state upon the torque tube rotating at a rotational velocity that meets or exceeds either of the first direction torque tube rotational velocity threshold and the second direction torque tube rotational velocity threshold.

18. The method of claim 16, wherein the centrifugal locking device is configured to transition from unlocked state to the locked state upon an applied wind load at the solar tracker causing the torque tube to rotate in the first rotational direction at a rotational velocity that meets or exceeds the first direction torque tube rotational velocity threshold.

19. The method of claim 14, wherein the centrifugal locking device comprises a housing, the housing comprising a first cable member receptacle groove extending around a perimeter of the housing and receiving the first cable member, the housing comprising a second cable member receptacle groove extending around the perimeter of the housing parallel to the first cable member receptacle groove and receiving the second cable member.

20. The method of claim 14, further comprising:
transitioning the centrifugal locking device from the locked state to the unlocked state upon termination of rotation of the torque tube in the first rotational direction at the rotational velocity that meets or exceeds the first direction torque tube rotational velocity threshold for a predetermined period of time.
